(19) United States
(12) Patent Application Publication
(10) Pub. No.: US 2015/0144240 A1
(43) Pub. Date: May 28, 2015

(54) Pneumatic Tire

(71) Applicant: The Yokohama Rubber Co., LTD., Minato-ku, Tokyo (JP)

(72) Inventor: Mizuki Takeuchi, Hiratsuka-shi (JP)

(21) Appl. No.: 14/404,427

(22) PCT Filed: May 31, 2013
(86) PCT No.: PCT/JP2013/065146

§ 371 Date: Nov. 26, 2014

(30) Foreign Application Priority Data
May 31, 2012 (JP) 2012-125333

(51) Int. Cl. B60C 1/00; C08L 7/00; C08L 9/00; B60C 11/00

(52) U.S. Cl. CPC B60C 1/00; B60C 11/005; C08L 7/00; C08L 9/00
USPC 152/209.5

(57) ABSTRACT

A rubber composition for an under tread of a tire comprises: relative to 100 parts by weight of diene rubber, from 15 to 45 parts by weight of carbon black and from 3 to 30 parts by weight of silica. An N₂SA of the carbon black is from 35 to 85 m²/g and a DBP absorption number of the carbon black is from 105 to 200 mL/100 g. A difference between a sulfur content of the rubber composition for the under tread (Y parts by weight) and a sulfur content of the rubber composition for coating that forms the belt layers (X parts by weight) (β=X−Y) is 4.5 or less, and a difference between the rubber hardness A of the cap tread and the rubber hardness B of the under tread (α=A−B) is from 5 to 12.

### TECHNICAL FIELD

The present technology relates to a pneumatic tire in which durability is maintained/enhanced while rolling resistance is reduced.

### BACKGROUND

Recently, increased interest in the global environmental issues has led to a demand for, as performance requirements, superior fuel consumption performance and superior tire durability in pneumatic tires. In particular, when a tread portion of a pneumatic tire is composed of a cap tread and an under tread, a rubber composition forming the under tread is required to have fuel efficiency performance and tire durability, as well as to enhance retreadability which is the secondary life of the pneumatic tires to or beyond conventional levels.

It is known that reducing rolling resistance can enhance fuel efficiency performance of a pneumatic tire. Therefore, heat build-up in a rubber composition composing pneumatic tires has been reduced, and rolling resistance, when a tire is produced, been made smaller.

As an indicator of the heat build-up in a rubber composition, typically, tan δ at 60° C. determined by dynamic visco-elasticity measurement and rubber hardness are used. Higher rubber hardness and smaller tan δ (60° C.) indicates smaller heat build-up. Furthermore, as an indicator of tire durability, it is required to have high rubber hardness, tensile strength at break, and tensile elongation at break, in particular, high tensile strength at break and tensile elongation at break at 100° C.

Japanese Patent No. 3207885B proposes to reduce tire rolling resistance by compounding from 3 to 35 parts by weight of carbon black having a nitrogen adsorption specific surface area N₂SA of 40 to 120 m²/g and a dibutyl phthalate oil absorption of 140 mL/100 g or greater per 100 parts by weight of diene rubber in a rubber composition for a base tread for steel belted radial tires for passenger cars. However, recently, demands for further decreasing rolling resistance and balancing low rolling resistance and tire durability at a higher level have been even more increased, and further improvement has been demanded. Moreover, in heavy duty pneumatic tires used for trucks and buses, it has been demanded to enhance retreadability to or beyond conventional levels.

### SUMMARY

The present technology provides a pneumatic tire in which, while reducing rolling resistance of the pneumatic tire, durability is maintained/enhanced and retreadability which is the secondary life is enhanced to or beyond conventional levels.

The pneumatic tire of the present technology is a pneumatic tire having an under tread and a cap tread arranged on belt layers embedded in a tread portion, the under tread being formed by a rubber composition for an under tread; the rubber composition for the under tread comprising: from 15 to 45 parts by weight of carbon black per 100 parts by weight of diene rubber, from 3 to 30 parts by weight of silica per 100 parts by weight of the diene rubber, and from 5 to 15% by weight, relative to the amount of the silica, of a silane coupling agent; the diene rubber comprising: from 70 to 90% by weight of natural rubber and/or isoprene rubber, and from 30 to 10% by weight of butadiene rubber and/or styrene butadiene rubber; a nitrogen adsorption specific surface area N₂SA of the carbon black being from 35 to 85 m²/g and a DBP absorption number of the carbon black being from 105 to 200 mL/100 g; if an amount of sulfur contained in the rubber composition for the under tread per 100 parts by weight of the diene rubber is Y parts by weight and if an amount of sulfur contained in a rubber composition for coating that forms the belt layers per 100 parts by weight of a rubber component is X parts by weight, a difference between the sulfur contents (β=X−Y) being 4.5 or less; and if a rubber hardness of the cap tread is A and if a rubber hardness of the under tread is B, a difference between the rubber hardnesses (α=A−B) being from 5 to 12.

The pneumatic tire of the present technology comprises an under tread, a cap tread, and belt layers. In the pneumatic tire, the rubber composition for the under tread comprises: relative to 100 parts by weight of diene rubber containing from 70 to 90% by weight of natural rubber and/or isoprene rubber and from 30 to 10% by weight of butadiene rubber and/or styrene butadiene rubber, from 15 to 45 parts by weight of carbon black having a nitrogen adsorption specific surface area N₂SA of 35 to 85 m²/g and a DBP absorption number of 105 to 200 mL/100 g and from 3 to 30 parts by weight of silica; and from 5 to 15% by weight, relative to the amount of the silica, of a silane coupling agent. Furthermore, in the pneumatic tire, the difference between a sulfur content of the rubber composition for the under tread (Y parts by weight) and a sulfur content of the rubber composition for coating that forms the belt layers (X parts by weight) (β=X−Y) is set to 4.5 or less, and the difference between the rubber hardness A of the cap tread and the rubber hardness B of the under tread (α=A−B) is set to 5 to 12. Therefore, the pneumatic tire of the present technology can maintain/enhance durability and retreadability while maintaining rubber hardness of the rubber composition for the under tread and reducing rolling resistance when a tire is produced by making tan δ (60° C.) small.

The diene rubber composing the rubber composition for the under tread preferably comprises from 80 to 90% by weight of the natural rubber and/or isoprene rubber, and from 20 to 10% by weight of the butadiene rubber.

In the rubber composition for the under tread, the compounded amount of the carbon black is preferably from 20 to 40 parts by weight, and the compounded amount of the silica is preferably from 5 to 25 parts by weight.

The pneumatic tire of the present technology is suitably used as a heavy duty pneumatic tire for trucks and buses, and can enhance durability and retreadability to or beyond conventional levels while making rolling resistance smaller and enhancing fuel efficiency performance.

### BRIEF DESCRIPTION OF THE DRAWING

FIG. 1 is a half cross-sectional view taken along a meridian of a tire illustrating an embodiment of the pneumatic tire of the present technology.

### DETAILED DESCRIPTION

The pneumatic tire of the present technology can be suitably used as, for example, tires for passenger cars, tires for sport utility vehicles (SUVs), and heavy duty tires for trucks, buses, and heavy construction vehicles, and the like. Of these, the pneumatic tire of the present technology can be suitably used as heavy duty pneumatic tires.

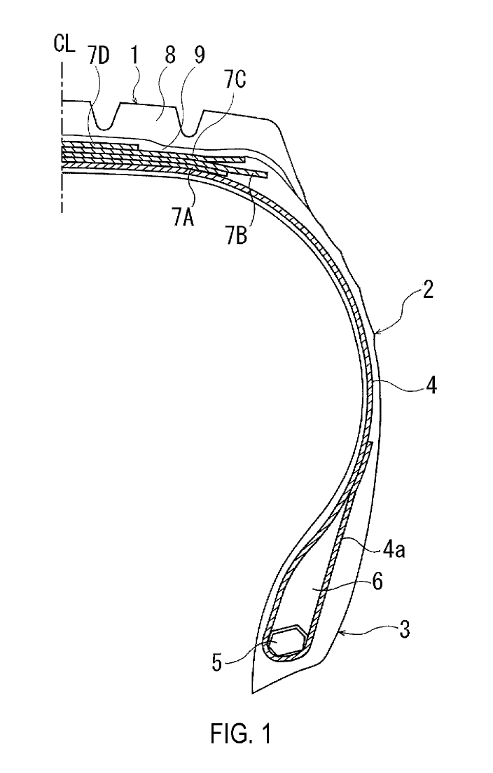

FIG. 1 illustrates an embodiment of a heavy duty pneumatic tire used in a truck, bus, or the like. The embodiment comprises a tread portion 1, a side wall portion 2, and a bead portion 3, and the tire equatorial plane is indicated by a symbol CL.

In FIG. 1, a carcass layer 4 is disposed extending between left and right side bead portions 3. Both ends 4a of the carcass layer 4 are made to sandwich a bead filler 6 around a bead core 5 that is embedded in the bead portions 3 and are folded back in a tire axial direction from the inside to the outside. A plurality of belt layers 7 (7A to 7D), formed by arranging steel cords inclined to the tire circumferential direction, is disposed on an outer circumferential side of the carcass layer 4 of the tread portion 1. The plurality of belt layers 7 is composed of a first belt layer 7A disposed adjacent to the carcass layer 4, a second belt layer 7B disposed on the outer circumferential side of the first belt layer 7A, a third belt layer 7C disposed on the outer circumferential side of the second belt layer 7B, and a fourth belt layer 7D disposed on the outer circumferential side of the third belt layer 7C. The steel cords of the second belt layer 7B and the steel cords of the third belt layer 7C cross so that the incline directions with respect to the tire circumferential direction are opposite each other. The plurality of belt layers 7 is disposed so as to be left-right symmetric with respect to the tire equatorial plane CL. These belt layers 7 (7A to 7D) are formed by coating the steel cords laid-out in parallel with a rubber composition for coating.

Furthermore, an under tread 9 is disposed on the outer circumferential side of the fourth belt layer 7D, and a cap tread 8 is disposed on the outer circumferential side of the under tread 9. The under tread 9 is formed by a rubber composition for an under tread, and the cap tread 8 is formed by a rubber composition for a cap tread.

In the rubber composition for the under tread, the diene rubber contains natural rubber and/or isoprene rubber, and butadiene rubber and/or styrene butadiene rubber, preferably butadiene rubber. By compounding the natural rubber and isoprene rubber, as main components, together with the butadiene rubber and styrene butadiene rubber, and specific carbon black and silica, heat build-up of the rubber composition can be made small, and tire durability can be enhanced by improving mechanical properties such as rubber hardness, tensile strength at break, and tensile elongation at break.

The compounded amount of the natural rubber and/or isoprene rubber is from 70 to 90% by weight, and preferably from 80 to 90% by weight, per 100% by weight of the diene rubber. When the compounded amount of the natural rubber and isoprene rubber is less than 70% by weight, tensile strength at break and tensile elongation at break of the rubber composition deteriorate. Furthermore, durability will be decreased when a tire is produced. When the compounded amount of the natural rubber and isoprene rubber exceeds 90% by weight, rubber hardness of the rubber composition decreases and heat build-up increases, thereby increasing rolling resistance when a tire is produced.

The compounded amount of the butadiene rubber and/or styrene butadiene rubber is from 30 to 10% by weight, and preferably from 20 to 10% by weight, per 100% by weight of the diene rubber. When the compounded amount of the butadiene rubber and styrene butadiene rubber is less than 10% by weight, rubber hardness and tensile strength at break of the rubber composition deteriorate. Furthermore, heat build-up will be increased, and rolling resistance will be increased when a tire is produced. When the compounded amount of the butadiene rubber and styrene butadiene rubber exceeds 30% by weight, tensile strength at break and tensile elongation at break of the rubber composition decreases, thereby decreasing durability when a tire is produced.

In the rubber composition for the under tread, the silica and the carbon black must be compounded. As described above, by compounding specific carbon black and silica together with the butadiene rubber and/or styrene butadiene rubber, heat build-up of the rubber composition can be made small, and tire durability can be enhanced by improving mechanical properties such as rubber hardness, tensile strength at break, and tensile elongation at break.

In the rubber composition for the under tread, mechanical properties, such as rubber hardness, tensile strength at break, and tensile elongation at break, do not deteriorate while tan δ (60° C.) of the rubber composition is made small using the carbon black that is, relatively, highly structured carbon black having a large particle diameter.

The carbon black used in the rubber composition for the under tread has a nitrogen specific surface area N₂SA of 35 to 85 m²/g, preferably 40 to 80 m²/g, and more preferably 40 to 70 m²/g. When the N₂SA is less than 35 m²/g, mechanical properties, such as rubber hardness, tensile strength at break, and wear resistance, of the rubber composition deteriorate. When the N₂SA exceeds 85 m²/g, tan δ (60° C.) increases thereby increasing heat build-up. The N₂SA is measured in accordance with JIS K6217-2.

Furthermore, a DBP absorption number of the carbon black is from 105 to 200 mL/100 g, preferably from 105 to 180 mL/100 g, and more preferably from 110 to 170 mL/100 g. When the DBP absorption number is less than 105 mL/100 g, reinforcing performance of the carbon black cannot be sufficiently obtained, and the tire durability decreases. When the DBP absorption number exceeds 200 mL/100 g, moldability/processability of the rubber composition decreases, and mechanical properties such as tensile strength at break and tensile elongation at break decrease, leading to deterioration of tire durability. Furthermore, processability deteriorates due to increase in viscosity. The DBP absorption number is measured in accordance with JIS K6217-4, Oil Absorption Number Method A.

The compounded amount of the carbon black is from 15 to 45 parts by weight, preferably from 20 to 40 parts by weight, and more preferably from 25 to 40 parts by weight, per 100 parts by weight of the diene rubber. When the compounded amount of the carbon black is less than 15 parts by weight, reinforcing performance for the rubber composition cannot be sufficiently obtained, and rubber hardness and tensile strength at break becomes insufficient. When the compounded amount of the carbon black exceeds 45 parts by weight, heat build-up of the rubber composition increases while tensile elongation at break decreases.

The compounded amount of the silica is from 3 to 30 parts by weight, preferably from 5 to 25 parts by weight, and more preferably from 7 to 23 parts by weight, per 100 parts by weight of the diene rubber. By setting the compounded amount of the silica in such a range, both low rolling resistance and durability can be achieved when a tire is produced. When the compounded amount of the silica is less than 3 parts by weight, heat build-up becomes large and rolling resistance, when a tire is produced, cannot be sufficiently made small. Furthermore, tensile strength at break decreases. When the compounded amount of the silica exceeds 30 parts by weight, tensile strength at break decreases thereby decreasing tire durability.

The total compounded amount of the silica and the carbon black is preferably from 20 to 75 parts by weight, and more preferably from 25 to 70 parts by weight, per 100 parts by weight of the diene rubber. By setting the total amount of the silica and the carbon black in such a range, the low rolling resistance and the durability of the rubber composition can be balanced at higher levels. When the total amount of the silica and the carbon black is less than 20 parts by weight, tire durability cannot be ensured. When the total amount of the silica and the carbon black exceeds 75 parts by weight, heat build-up increases thereby deteriorating rolling resistance.

As the silica used in the rubber composition for the under tread, a silica that is typically used in rubber compositions for use in tires can be compounded. Types of silicas that can be used include, for example, wet method silicas, dry method silicas, surface treated silicas, and the like.

In the rubber composition for the under tread, a silane coupling agent is blended together with the silica so as to improve the dispersibility of the silica and to further increase the reinforcement properties with rubber components. The compounded amount of the silane coupling agent is from 5 to 15% by weight, and preferably from 7 to 13% by weight, relative to the amount of silica. When the compounded amount of the silane coupling agent is less than 5% by weight of the silica weight, the effect of improving the dispersion of the silica cannot be sufficiently obtained. Furthermore, when the compounded amount of the silane coupling agent exceeds 15% by weight, the silane coupling agents will condense, and the desired effects cannot be obtained.

The silane coupling agent is not particularly limited, but is preferably a sulfur-containing silane coupling agent. Examples thereof include bis-(3-triethoxysilylpropyl)tetrasulfide, bis(3-triethoxysilylpropyl)disulfide, 3-trimethoxysilylpropyl benzothiazole tetrasulfide, γ-mercaptopropyltriethoxysilane, 3-octanoylthiopropyl triethoxysilane, and the like.

The rubber composition for the under tread contains sulfur. The content of sulfur in the rubber composition for the under tread per 100 parts by weight of the diene rubber is Y parts by weight in the present specification. The compounded amount of sulfur (Y) is preferably from 1.5 to 2.5 parts by weight, and more preferably from 1.65 to 2.15 parts by weight.

In the pneumatic tire of the present technology, belt layers 7 (7A to 7D) are formed by coating the steel cords laid-out in parallel with a rubber composition for coating. As the rubber composition for coating, a rubber composition typically used in a rubber composition for coating cords of pneumatic tires can be employed.

In the rubber composition for coating, a base rubber component can be composed of diene rubbers including natural rubber, isoprene rubber, butadiene rubber, styrene butadiene rubber, butyl rubber, and the like. Furthermore, the rubber composition for coating contains sulfur. The content of sulfur in the rubber composition for coating per 100 parts by weight of the diene rubber is X parts by weight in the present specification.

In the pneumatic tire of the present technology, the difference between a sulfur content of the rubber composition for the under tread (Y parts by weight) and a sulfur content of the rubber composition for coating (X parts by weight) (β=X−Y) is set to 4.5 or less, and preferably set to from 0 to 4.0. The difference β of the sulfur contents is more preferable as it approaches zero. When the difference β of the sulfur contents exceeds 4.5, since sulfur, which serves an important role in adhesion toward metal, transfers from the belt layers to the under tread due to concentration gradient, adhesion in the belt layers becomes unfavorable and, as a result, retreadability deteriorates. In the present specification, retreadability of a pneumatic tire being good refers to a condition in which a retreaded tire which has undergone retreading treatment after use maintains practically sufficient levels of tire durability.

In the pneumatic tire of the present technology, if a rubber hardness of the cap tread 8 is A and if a rubber hardness of the under tread 9 is B, a difference α between the rubber hardnesses (α=A−B) being from 5 to 12, preferably from 6 to 12, and more preferably from 7 to 11. When the difference α of the rubber hardnesses is less than 5, the cap tread and the under tread are entirely deformed, and deformation in the cap tread that has a relatively large heat build-up becomes greater, thereby making durability unfavorable. Furthermore, when the difference α of the rubber hardnesses exceeds 12, the difference between the hardnesses of the cap tread and the under tread becomes too large, and excessive stress will be applied to the under tread, thereby making durability unfavorable. In the present specification, “rubber hardnesses of the cap tread and the under tread” refers to rubber hardnesses measured in accordance with JIS K6253 using a type A durometer at a temperature of 20° C.

As the rubber composition for the cap tread of the present technology, a rubber composition typically used in a cap tread of pneumatic tires can be employed.

The rubber composition for the under tread, the rubber composition for the cap tread, and the rubber composition for coating can also contain various types of additives that are commonly used in rubber compositions for use in tires, such as vulcanization and crosslinking agents, vulcanization accelerators, various types of inorganic fillers, various types of oils, antiaging agents, and plasticizers. These additives may be kneaded according to any common method to form a rubber composition and may be used in vulcanization or crosslinking. The compounded amount of these additives may be any conventional amount, as long as the object of the present technology is not impaired. The rubber composition for a tire can be produced by mixing each of the components described above using a commonly used rubber kneading machine such as a Banbury mixer, a kneader, and a roller.

The rubber composition for the under tread can be suitably used for an under tread portion of pneumatic tires, especially for an under tread portion of heavy duty tires for trucks, buses, and the like. With pneumatic tires in which the under tread portion is formed from the rubber composition for an under tread, since heat build-up while traveling can be made small and thus rolling resistance can be made small, fuel consumption performance can be enhanced. At the same time, since mechanical properties of the constituting rubber composition is enhanced, tire durability can be enhanced to or beyond conventional levels. Furthermore, since the difference β between the sulfur content of the rubber composition for the under tread and the sulfur content of the rubber composition for coating constituting the adjacent belt layers disposed inner side in the tire radial direction is adjusted, retreadability which is the secondary life can be enhanced to or beyond conventional levels.

The present technology is further explained below by working examples. However, the scope of the present technology is not limited to these working examples.

### Examples

31 types of rubber compositions for under treads (Working Examples 1 to 7 and Comparative Examples 1 to 24) containing a composition using 5 types of carbon blacks (CB 1 to CB 5) described in Tables 1 to 4, and additives described in Table 5 were prepared. When each of the rubber compositions for under treads were prepared, the components except for the sulfur and the vulcanization accelerator were weighed and kneaded for 15 minutes using a 55 L kneader, and then the master batch was discharged to cool at room temperature. This master batch was fed in a 55 L kneader, and then the sulfur and the vulcanization accelerator were added to the master batch and mixed to obtain a rubber composition for an under tread. Note that the compounded amount of the common additives in Table 5 are described in parts by weight relative to 100 parts by weight of the diene rubber described in Tables 1 to 4.

Test pieces were produced by vulcanizing the obtained 31 types of rubber compositions in respective molds with a prescribed shape at 150° C. for 30 minutes. Tensile characteristics, rubber hardness, and dynamic visco-elasticity were evaluated according to the methods described below.

### Rubber Hardness

In accordance with JIS K6253, a type A durometer was used to measure the rubber hardness of the obtained test pieces at a temperature of 20° C. The obtained results are shown on the “Rubber hardness” rows of Tables 1 to 4, with the value of Comparative Example 1 expressed as an index of 100. Larger index values indicates higher rubber hardness, which indicates lower rolling resistance and superior fuel consumption performance when a pneumatic tire is produced.

### Tensile Characteristics

JIS #3 dumbbell test pieces (thickness: 2 mm) were punched from the obtained test pieces in accordance with JIS K6251. The test was conducted at 100° C. at a pulling rate of 500 mm/minute, and tensile strength at break and tensile elongation at break were measured. The obtained results of tensile strength at break at 100° C. are shown on the “TB @100° C.” rows and the obtained results of tensile elongation at break at 100° C. are shown on the “EB @100° C.” rows of Tables 1 to 4, with the value of Comparative Example 1 expressed as an index of 100. Larger index values for “TB@100° C.” mean larger tensile strength at break, and larger index values for “EB@100° C.” mean larger tensile elongation indicating that durability, when a pneumatic tire is produced, will be superior.

### Dynamic Visco-Elasticity

Using a viscoelastic spectrometer, manufactured by Toyo Seiki Seisaku-sho, Ltd., the loss tangent, tan δ, at a temperature of 60° C. of the obtained test piece was measured in accordance with JIS K6394 under conditions at an initial distortion of 10%, an amplitude of ±2%, and a frequency of 20 Hz. The obtained results are shown on the “tan δ @60° C.” rows of Tables 1 to 4, with the value of Comparative Example 1 expressed as an index of 100. Smaller index values indicates smaller heat build-up, and lower rolling resistance and superior fuel consumption performance when a pneumatic tire is produced.

Pneumatic tires having the following tire size were vulcanization-molded in a manner that under tread portions were formed using the obtained 31 types of rubber compositions for under treads, and cap tread portions were formed using the rubber composition for cap treads shown in Table 6, and belt layers were formed by the rubber composition for coating shown in Table 7.

Note that, for the rubber composition for cap treads in Table 6, rubber hardness of cap treads were adjusted by increasing or decreasing the compounded amount of carbon blacks. The difference α between rubber hardness A of the obtained cap tread and rubber hardness B of each under tread (α=A−B) are shown in “Difference α between rubber hardnesses” rows in Tables 1 to 4.

Furthermore, for the rubber composition for coating in Table 7, difference between the sulfur content in the rubber composition for coating and the sulfur content in the rubber compositions for under treads were adjusted by increasing or decreasing the compounded amount of sulfur as necessary. The difference β between a sulfur content of the rubber composition for the under tread (Y parts by weight) and a sulfur content of the rubber composition for coating that formed the belt layers (X parts by weight) (β=X−Y) are shown in “Difference β between sulfur contents” rows in Tables 1 to 4.

Rolling resistance, durability, and retreadability of the obtained 31 types of pneumatic tires were evaluated according to the methods described below.

### Rolling Resistance

A pneumatic tire having a tire size of 275/80R22.5 was vulcanization-molded, and the obtained tire was assembled on a standard rim (wheel size: 22.5×8.25). The assembly was then mounted on an indoor drum testing machine (drum diameter: 1,707 mm) in accordance with JIS D4230, and rolling resistance was determined by measuring the resistance at a speed of 80 km/hr under air pressure of 900 kPa, using a load of 33.8 kN. The obtained results are shown on the “Rolling resistance” rows of Tables 1 to 4, with the value of Comparative Example 1 expressed as an index of 100. Smaller index values indicate lower rolling resistance and superior fuel consumption performance.

### Durability

A pneumatic tire having a tire size of 275/80R22.5 was vulcanization-molded, and the obtained tire was assembled on a standard rim (wheel size: 22.5×8.25). The assembly was then mounted on an indoor drum testing machine (drum diameter: 1,707 mm) in accordance with JIS D4230, and a running test was started at a speed of 45 km/hr with a slip angle of 2 degrees under air pressure of 900 kPa, using an initial load of 33.8 kN. After starting the test, the load was increased by 10% of the initial load every 24 hours, and the running test was continued until the tire was broken. The running distance until the tire breakage was measured. The obtained results are shown on the “Durability” rows of Tables 1 to 4, with the running distance of Comparative Example 1 expressed as an index of 100. Larger index values indicate superior tire durability.

### Retreadability

A pneumatic tire having a tire size of 275/80R22.5 was vulcanization-molded, and the obtained tire was assembled on a standard rim (wheel size: 22.5×8.25). The assembly was then mounted on an indoor drum testing machine (drum diameter: 1,707 mm) in accordance with JIS D4230, and a preliminary running test was started at a speed of 45 km/hr under air pressure of 900 kPa caused by using a mixed gas containing 55% of oxygen, using a load of 47.4 kN, for 240 hours. After the completion of the preliminary running test, the tire was subjected to a retreading treatment. Using the obtained retreaded tire, a running test was started at a speed of 45 km/hr with a slip angle of 2 degrees under air pressure of 900 kPa, using an initial load of 33.8 kN. After starting the test, the load was increased by 10% of the initial load every 24 hours, and the running test was continued until the tire was broken. The running distance until the tire breakage was measured. The obtained results are shown on the “Retreadability” rows of Tables 1 to 4, with the running distance of Comparative Example 1 expressed as an index of 100. Larger index values indicate superior retreaded tire durability.

TABLE 1

| | | Comparative | Comparative | Comparative | Comparative |
|---|---|---|---|---|---|
| | | Example 1 | Example 2 | Example 3 | Example 4 |
| NR | pbw | 100 | 100 | 100 | 100 |
| BR | pbw | | | | |
| CB 3 | pbw | 45 | 45 | 45 | 45 |
| Silica | pbw | | | | |
| Coupling agent | pbw | | | | |
| Difference α | — | 10 | 3 | 6 | 10 |
| between rubber | | | | | |
| hardnesses | | | | | |
| Difference β | pbw | 5 | 5 | 5 | 3.5 |
| between sulfur | | | | | |
| contents | | | | | |
| Hardness | Index | 100 | 100 | 100 | 100 |
| | value | | | | |
| tanδ @60° C. | Index | 100 | 100 | 100 | 100 |
| | value | | | | |
| TB @100° C. | Index | 100 | 100 | 100 | 100 |
| | value | | | | |
| EB @100° C. | Index | 100 | 100 | 100 | 100 |
| | value | | | | |
| Rolling | Index | 100 | 100 | 100 | 100 |
| resistance | value | | | | |
| Durability | Index | 100 | 90 | 97 | 100 |
| | value | | | | |
| Retreadability | Index | 100 | 100 | 100 | 110 |
| | value | | | | |
| | | Comparative | Comparative | Comparative | Comparative |
| | | Example 5 | Example 6 | Example 7 | Example 8 |
| NR | pbw | 100 | 85 | 100 | 95 |
| BR | pbw | | 15 | | 5 |
| CB 3 | pbw | 45 | 45 | 32 | 32 |
| Silica | pbw | | | 13 | 13 |
| Coupling agent | pbw | | | 1.3 | 1.3 |
| Difference α | — | 14 | 10 | 10 | 10 |
| between rubber | | | | | |
| hardnesses | | | | | |
| Difference β | pbw | 3.5 | 3.5 | 3.5 | 3.5 |
| between sulfur | | | | | |
| contents | | | | | |
| Hardness | Index | 100 | 100 | 93 | 94 |
| | value | | | | |
| tanδ @60° C. | Index | 100 | 99 | 75 | 75 |
| | value | | | | |
| TB @100° C. | Index | 100 | 88 | 97 | 94 |
| | value | | | | |
| EB @100° C. | Index | 100 | 90 | 116 | 116 |
| | value | | | | |
| Rolling | Index | 104 | 100 | 103 | 102 |
| resistance | value | | | | |
| Durability | Index | 87 | 88 | 107 | 106 |
| | value | | | | |
| Retreadability | Index | 109 | 110 | 109 | 110 |
| | value | | | | |

TABLE 2

| | | Comparative | Working | Comparative | Comparative |
|---|---|---|---|---|---|
| | | Example 9 | Example 1 | Example 10 | Example 11 |
| NR | pbw | 85 | 85 | 85 | 85 |
| BR | pbw | 15 | 15 | 15 | 15 |
| CB 1 | pbw | | | | |
| CB 2 | pbw | | | | |
| CB 3 | pbw | 32 | 32 | 32 | 32 |
| Silica | pbw | 13 | 13 | 13 | 13 |
| Coupling agent | pbw | 1.3 | 1.3 | 1.3 | 1.3 |
| Difference α | — | 3 | 10 | 10 | 14 |
| between rubber | | | | | |
| hardnesses | | | | | |
| Difference β | pbw | 3.5 | 3.5 | 5 | 3.5 |
| between sulfur | | | | | |
| contents | | | | | |
| Hardness | Index | 99 | 99 | 99 | 99 |
| | value | | | | |
| tanδ @60° C. | Index | 75 | 75 | 75 | 75 |
| | value | | | | |
| TB @100° C. | Index | 107 | 107 | 107 | 107 |
| | value | | | | |
| EB @100° C. | Index | 122 | 122 | 122 | 122 |
| | value | | | | |
| Rolling | Index | 92 | 92 | 92 | 96 |
| resistance | value | | | | |
| Durability | Index | 99 | 129 | 129 | 97 |
| | value | | | | |
| Retreadability | Index | 110 | 110 | 100 | 110 |
| | value | | | | |

| | | Working | Comparative | Comparative | Comparative |
|---|---|---|---|---|---|
| | | Example 2 | Example 12 | Example 13 | Example 14 |
| NR | pbw | 75 | 65 | 85 | 85 |
| BR | pbw | 25 | 35 | 15 | 15 |
| CB 1 | pbw | | | 32 | |
| CB 2 | pbw | | | | 32 |
| CB 3 | pbw | 32 | 32 | | |
| Silica | pbw | 13 | 13 | 13 | 13 |
| Coupling agent | pbw | 1.3 | 1.3 | 1.3 | 1.3 |
| Difference α | — | 10 | 10 | 10 | 10 |
| between rubber | | | | | |
| hardnesses | | | | | |
| Difference β | pbw | 3.5 | 3.5 | 3.5 | 3.5 |
| between sulfur | | | | | |
| contents | | | | | |
| Hardness | Index | 102 | 104 | 108 | 104 |
| | value | | | | |
| tanδ @60° C. | Index | 73 | 71 | 115 | 102 |
| | value | | | | |
| TB @100° C. | Index | 100 | 68 | 120 | 112 |
| | value | | | | |
| EB @100° C. | Index | 117 | 93 | 140 | 130 |
| | value | | | | |
| Rolling | Index | 90 | 89 | 105 | 102 |
| resistance | value | | | | |
| Durability | Index | 108 | 78 | 128 | 121 |
| | value | | | | |
| Retreadability | Index | 110 | 111 | 111 | 110 |
| | value | | | | |

TABLE 3

| | | Working | Comparative | Comparative | Comparative |
|---|---|---|---|---|---|
| | | Example 3 | Example 15 | Example 16 | Example 17 |
| NR | pbw | 85 | 85 | 85 | 85 |
| BR | pbw | 15 | 15 | 15 | 15 |
| CB 3 | pbw | | | | |
| CB 4 | pbw | 32 | 32 | 32 | |
| CB 5 | pbw | | | | 32 |
| Silica | pbw | 13 | 13 | 13 | 13 |
| Coupling agent | pbw | 1.3 | 1.3 | 1.3 | 1.3 |
| Difference α | — | 10 | 10 | 14 | 10 |
| between rubber | | | | | |
| hardnesses | | | | | |
| Difference β | pbw | 3.5 | 5 | 3.5 | 3.5 |
| between sulfur | | | | | |
| contents | | | | | |
| Hardness | Index | 99 | 99 | 99 | 90 |
| | value | | | | |
| tanδ @60° C. | Index | 70 | 70 | 70 | 59 |
| | value | | | | |
| TB @100° C. | Index | 105 | 105 | 105 | 63 |
| | value | | | | |
| EB @100° C. | Index | 119 | 119 | 119 | 71 |
| | value | | | | |
| Rolling | Index | 88 | 88 | 93 | 76 |
| resistance | value | | | | |
| Durability | Index | 115 | 115 | 99 | 94 |
| | value | | | | |
| Retreadability | Index | 110 | 99 | 110 | 108 |
| | value | | | | |

| | | Comparative | Working | Comparative |
|---|---|---|---|---|
| | | Example 18 | Example 4 | Example 19 |
| NR | pbw | 85 | 85 | 85 |
| BR | pbw | 15 | 15 | 15 |
| CB 3 | pbw | 43 | 35 | 35 |
| CB 4 | pbw | | | |
| CB 5 | pbw | | | |
| Silica | pbw | 2 | 7 | 7 |
| Coupling agent | pbw | 0.2 | 1.0 | 1.0 |
| Difference α | — | 10 | 10 | 14 |
| between rubber | | | | |
| hardnesses | | | | |
| Difference β | pbw | 3.5 | 3.5 | 3.5 |
| between sulfur | | | | |
| contents | | | | |
| Hardness | Index | 100 | 99 | 99 |
| | value | | | |
| tanδ @60° C. | Index | 95 | 86 | 86 |
| | value | | | |
| TB @100° C. | Index | 86 | 102 | 102 |
| | value | | | |
| EB @100° C. | Index | 93 | 109 | 109 |
| | value | | | |
| Rolling | Index | 100 | 98 | 102 |
| resistance | value | | | |
| Durability | Index | 90 | 108 | 97 |
| | value | | | |
| Retreadability | Index | 100 | 110 | 110 |
| | value | | | |

TABLE 4

| | | Working | Comparative | Comparative | Working |
|---|---|---|---|---|---|
| | | Example 5 | Example 20 | Example 21 | Example 6 |
| NR | pbw | 85 | 85 | 95 | 80 |
| BR | pbw | 15 | 15 | | |
| SBR | pbw | | | 5 | 20 |
| CB 3 | pbw | 25 | 10 | 32 | 32 |
| Silica | pbw | 23 | 35 | 13 | 13 |
| Coupling agent | pbw | 2 | 3.5 | 1.3 | 1.3 |
| Difference α | — | 10 | 10 | 10 | 10 |
| between rubber | | | | | |
| hardnesses | | | | | |
| Difference β | pbw | 3.5 | 3.5 | 3.5 | 3.5 |
| between sulfur | | | | | |
| contents | | | | | |
| Hardness | Index | 98 | 92 | 94 | 100 |
| | value | | | | |
| tanδ @60° C. | Index | 54 | 39 | 78 | 86 |
| | value | | | | |
| TB @100° C. | Index | 101 | 80 | 98 | 100 |
| | value | | | | |
| EB @100° C. | Index | 135 | 159 | 114 | 105 |
| | value | | | | |
| Rolling | Index | 90 | 99 | 103 | 98 |
| resistance | value | | | | |
| Durability | Index | 115 | 94 | 107 | 105 |
| | value | | | | |
| Retreadability | Index | 111 | 111 | 110 | 110 |
| | value | | | | |

| | | Comparative | Comparative | Comparative | Working |
|---|---|---|---|---|---|
| | | Example 22 | Example 23 | Example 24 | Example 7 |
| NR | pbw | 80 | 80 | 65 | 80 |
| BR | pbw | | | | 10 |
| SBR | pbw | 20 | 20 | 35 | 10 |
| CB 3 | pbw | 32 | 32 | 32 | 32 |
| Silica | pbw | 13 | 13 | 13 | 13 |
| Coupling agent | pbw | 1.3 | 1.3 | 1.3 | 1.3 |
| Difference α | — | 10 | 14 | 10 | 10 |
| between rubber | | | | | |
| hardnesses | | | | | |
| Difference β | pbw | 5 | 3.5 | 3.5 | 3.5 |
| between sulfur | | | | | |
| contents | | | | | |
| Hardness | Index | 100 | 100 | 105 | 100 |
| | value | | | | |
| tanδ @60° C. | Index | 86 | 86 | 101 | 78 |
| | value | | | | |
| TB @100° C. | Index | 100 | 100 | 89 | 98 |
| | value | | | | |
| EB @100° C. | Index | 105 | 105 | 86 | 114 |
| | value | | | | |
| Rolling | Index | 98 | 103 | 95 | 97 |
| resistance | value | | | | |
| Durability | Index | 105 | 96 | 85 | 107 |
| | value | | | | |
| Retreadability | Index | 100 | 110 | 109 | 110 |
| | value | | | | |

The types of raw materials used in Tables 1 to 4 are described below.
NR: natural rubber, STR 20
BR: butadiene rubber; Nipol BR1220, manufactured by Zeon Corporation
SBR: butadiene rubber; Nipol 1502, manufactured by Zeon Corporation
CB 1: Niteron #300IH, manufactured by NSCC Carbon Co., Ltd.; N₂SA=120 m²/g, DBP absorption number=126 mL/100 g
CB 2: Niteron #200IS, manufactured by NSCC Carbon Co., Ltd.; N₂SA=95 m²/g, DBP absorption number=122 mL/100 g
CB 3: SEAST 116HM, manufactured by Tokai Carbon Co., Ltd.; N₂SA=56 m²/g, DBP absorption number=158 mL/100 g
CB 4: SEAST SO, manufactured by Tokai Carbon Co., Ltd.; N₂SA=42 m²/g, DBP absorption number=115 mL/100 g
CB 5: Niteron #55S, manufactured by NSCC Carbon Co., Ltd.; N₂SA=28 m²/g, DBP absorption number=88 mL/100 g
Silica: Nipsil AQ, manufactured by Tosoh Silica Corporation
Coupling agent: silane coupling agent; Si 69, manufactured by Evonik Degussa

TABLE 5
Common additive formulation of rubber composition

| | |
|---|---|
| Zinc oxide | 3.0 pbw |
| Stearic acid | 1.5 pbw |
| Antiaging agent | 1.5 pbw |
| Sulfur | 2.0 pbw |
| Vulcanization accelerator | 1.5 pbw |

The types of raw materials used in Table 5 are shown below.
Zinc oxide: Zinc Oxide #3, manufactured by Seido Chemical Industry Co., Ltd.
Stearic acid: beads stearic acid, manufactured by NOF Corporation
Antioxidant: Santoflex 6PPD, manufactured by Flexsys
Sulfur: “Golden Flower” oil-treated sulfur powder, manufactured by Tsurumi Chemical Industry, Co., Ltd.
Vulcanization accelerator: Nocceler NS-P, manufactured by Ouchi Shinko Chemical Industrial Co., Ltd.

TABLE 6
Standard composition of rubber composition for cap tread

| | | |
|---|---|---|
| Natural rubber | 80.0 | pbw |
| Styrene butadiene rubber | 20.0 | pbw |
| Carbon black HAF | 20.0 | pbw |
| Carbon black ISAF | 35.0 | pbw |
| Zinc oxide | 3.0 | pbw |
| Stearic acid | 1.0 | pbw |
| Antiaging agent | 2.0 | pbw |
| Sulfur | 2.0 | pbw |
| Vulcanization accelerator | 1.0 | pbw |

TABLE 7
Standard composition of rubber composition for coating

| | | |
|---|---|---|
| Natural rubber | 100.0 | pbw |
| Carbon black HAF | 55.0 | pbw |
| Organic acid cobalt salt | 1.0 | pbw |
| Zinc oxide | 8.0 | pbw |
| Stearic acid | 1.0 | pbw |
| Antiaging agent | 2.0 | pbw |
| Sulfur | 5.5 | pbw |
| Vulcanization accelerator | 1.0 | pbw |

As clearly shown in Tables 1 to 4, it was confirmed that the rubber compositions for the under treads of Working Examples 1 to 7 maintained/enhanced the rubber hardness, tensile strength at break, and tensile elongation at break to or beyond conventional levels. Furthermore, it was also confirmed that the pneumatic tires using these rubber compositions for under treads maintained/enhanced the low rolling resistance, tire durability, and retreadability (durability of the retreaded tire) to or beyond conventional levels.

As clearly shown in Table 1, the rubber compositions for the under treads of Comparative Examples 2 to 5 had the same composition as the rubber composition for the under tread of Comparative Example 1 which did not contain the silica, and the rubber hardness, tensile strength at break, and tensile elongation at break were the same. Since the pneumatic tire of Comparative Example 2 had the difference α between rubber hardnesses of less than 5, the tire durability deteriorated compared to that of Comparative Example 1. Since the pneumatic tire of Comparative Example 4 had the difference β between sulfur contents of greater than 4.5, the retreadability of the tire deteriorated compared to that of Comparative Example 1. Since the pneumatic tire of Comparative Example 5 had the difference α between rubber hardnesses of greater than 12, the tire durability deteriorated compared to that of Comparative Example 1.

Since the rubber composition for the under tread of Comparative Example 6 did not contain the silica even though the butadiene rubber was contained, the tensile strength at break and the tensile elongation at break decreased, thereby making the durability worse. Since the rubber composition for the under tread of Comparative Example 7 did not contain the butadiene rubber even though the silica was contained, the rubber hardness and tensile strength at break deteriorated. Since, in the rubber composition for the under tread of Comparative Example 8, the compounded amount of the natural rubber exceeded 90 parts by weight and the compounded amount of the butadiene rubber was less than 10 parts by weight, the rubber hardness and tensile strength at break deteriorated.

As clearly shown in Table 2, since the pneumatic tire of Comparative Example 9 had the difference α between rubber hardnesses of less than 5, the tire durability deteriorated compared to that of the pneumatic tire of Working Example 1. Since the pneumatic tire of Comparative Example 10 had the difference β between sulfur contents of greater than 4.5, the retreadability of the tire deteriorated compared to that of the pneumatic tire of Working Example 1. Since the pneumatic tire of Comparative Example 11 had the difference α between rubber hardnesses of greater than 12, the tire durability deteriorated compared to that of the pneumatic tire of Working Example 1.

Since, in the rubber composition for the under tread of Comparative Example 12, the compounded amount of the natural rubber was less than 70 parts by weight, and the compounded amount of the butadiene rubber exceeded 30 parts by weight, the tensile strength at break and tensile elongation at break decreased, thereby making the durability worse. Since the rubber compositions of Comparative Examples 13 and 14 contained the carbon black CB 1 and CB 2 having the N₂SA exceeding 85 m²/g, the values of tan δ were increased, thereby making the rolling resistance worse.

As clearly shown in Table 3, since the pneumatic tire of Comparative Example 15 had the difference β between sulfur contents of greater than 4.5, the retreadability of the tire deteriorated compared to that of the pneumatic tire of Working Example 3. Since the pneumatic tire of Comparative Example 16 had the difference α between rubber hardnesses of greater than 12, the tire durability deteriorated compared to that of the pneumatic tire of Working Example 3.

Since, in the rubber composition for the under tread of Comparative Example 17, the carbon black CB 5 had the N₂SA of less than 35 m²/g and the DBP absorption number of less than 105 mL/100 g, the tensile strength at break and tensile elongation at break decreased, thereby making the durability worse. Since, in the rubber composition for the under tread of Comparative Example 18, the compounded amount of the silica was less than 3 parts by weight, the tensile strength at break and tensile elongation at break decreased, thereby making the durability worse. Since the pneumatic tire of Comparative Example 19 had the difference α between rubber hardnesses of greater than 12, the tire durability deteriorated compared to that of the pneumatic tire of Working Example 4.

As clearly shown in Table 4, since, in the rubber composition for the under tread of Comparative Example 20, the compounded amount of the carbon black was less than 15 parts by weight and the compounded amount of the silica exceeded 30 parts by weight, the tensile strength at break decreased, and the durability of the pneumatic tire deteriorated. Since, in the rubber composition for the under tread of Comparative Example 21, the compounded amount of the natural rubber exceeded 90 parts by weight and the compounded amount of the styrene butadiene rubber was less than 10 parts by weight, although the value of tan δ decreased due to the compounding effect of the silica, the rubber hardness decreased and the rolling resistance deteriorated.

Since the pneumatic tire of Comparative Example 22 had the difference β between sulfur contents of greater than 4.5, the retreadability of the tire deteriorated compared to that of the pneumatic tire of Working Example 6. Since the pneumatic tire of Comparative Example 23 had the difference α between rubber hardnesses of greater than 12, the tire durability deteriorated compared to that of the pneumatic tire of Working Example 6.

Since, in the rubber composition for the under tread of Comparative Example 24, the compounded amount of the natural rubber was less than 70 parts by weight, and the compounded amount of the styrene butadiene rubber exceeded 30 parts by weight, the tensile strength at break and tensile elongation at break decreased, thereby making the durability worse.

1. A pneumatic tire having an under tread and a cap tread arranged on belt layers embedded in a tread portion, the under tread being formed by a rubber composition for an under tread;
the rubber composition for the under tread comprising:
from 15 to 45 parts by weight of carbon black per 100 parts by weight of diene rubber,
from 3 to 30 parts by weight of silica per 100 parts by weight of the diene rubber, and
from 5 to 15% by weight, relative to the amount of the silica, of a silane coupling agent;
the diene rubber comprising:
from 70 to 90% by weight of natural rubber and/or isoprene rubber, and
from 30 to 10% by weight of butadiene rubber and/or styrene butadiene rubber;
a nitrogen adsorption specific surface area N₂SA of the carbon black being from 35 to 85 m²/g and a DBP absorption number of the carbon black being from 105 to 200 mL/100 g;
if an amount of sulfur contained in the rubber composition for the under tread per 100 parts by weight of the diene rubber is Y parts by weight and if an amount of sulfur contained in a rubber composition for coating that forms the belt layers per 100 p arts by weight of a rubber component is X parts by weight, a difference between the sulfur contents (β=X−Y) being 4.5 or less; and
if a rubber hardness of the cap tread is A and if a rubber hardness of the under tread is B, a difference between the rubber hardnesses (α=A−B) being from 5 to 12.

2. The pneumatic tire according to claim 1, wherein the diene rubber composing the rubber composition for the under tread comprises from 80 to 90% by weight of the natural rubber and/or isoprene rubber, and from 20 to 10% by weight of the butadiene rubber.

3. The pneumatic tire according to claim 2, wherein the rubber composition for the under tread comprises from 20 to 40 parts by weight of the carbon black, and from 5 to 25 parts by weight of the silica.

4. The pneumatic tire according to claim 3, wherein the pneumatic tire is a heavy duty pneumatic tire used for a truck or a bus.

5. The pneumatic tire according to claim 2, wherein the pneumatic tire is a heavy duty pneumatic truck tire or bus tire.

6. The pneumatic tire according to claim 1, wherein the rubber composition for the under tread comprises from 20 to 40 parts by weight of the carbon black, and from 5 to 25 parts by weight of the silica.

7. The pneumatic tire according to claim 1, wherein the pneumatic tire is a heavy duty pneumatic truck tire or bus tire.
